(19) United States
(12) Patent Application Publication
(10) Pub. No.: US 2011/0283985 A1
(43) Pub. Date: Nov. 24, 2011

(54) DEMOLITION BIT WITH BOUNCE BACK BIT EXTRACTOR

(76) Inventor: Michael P. Valerio, Penfield, NY (US)

(21) Appl. No.: 12/783,647

(22) Filed: May 20, 2010

(51) Int. Cl. B28D 1/26; B25D 17/02; B25D 17/24

(52) U.S. Cl. 125/40; 225/103; 225/1; 173/211

(57) ABSTRACT

The invention provides a demolition tool comprising a chisel and a bounce back element.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The invention relates to bits for demolition tools. It particularly relates to demolition bits for air powered percussion hammers.

2. Description of Related Art

In the construction and demolition industries, the use of air powered percussion hammers to break up existing concrete is well known. Such hammers use a chisel that is hammered into the existing concrete and causes the concrete to crack and break up so that it can be removed by loading equipment. One difficulty with the percussion air hammer and chisel bits is that the bits may become trapped in the concrete if it does not crack. Then it is difficult for the operator to withdraw the bit and slows down the demolition.

U.S. Pat. No. 4,993,894 to Fischer discloses a masonry drill bit that includes a stop to control hole depth. The drill stop also has a resilient element that serves as an anti-vibration element.

U.S. Pat. No. 6,609,860 to Wanek also discloses a stop that limits the hole depth of a masonry drill.

U.S. Pat. No. 4,548,279 to Zaruba discloses a demolition tool that is provided with an extractor for pulling the chisel from the work surface when it becomes difficult to remove.

There remains a need for an apparatus and method to allow rapid release of a demolition chisel from concrete. There remains a need for a method of removing demolition chisels from concrete that does not delay demolition. There remains need for a method of removing chisels from concrete that is not tiring to the operator of the percussion demolition tool and does not cause delays.

### BRIEF SUMMARY OF THE INVENTION

The invention relates to a demolition tool comprising a chisel comprising a bounce back feature.

### BRIEF DESCRIPTION OF THE SEVERAL VIEWS OF THE DRAWING(S)

FIG. 1 is a prospective view of a percussion air hammer with the bounce back element installed.

FIG. 2 is a view of a chisel that is provided with the bounce back element of the invention.

FIG. 3 is a view of the assembling of the chisel with the bounce back element.

FIG. 4 and FIG. 5 are top and bottom views of the elastomeric member used in forming the bounce back element.

FIG. 6 and FIG. 7 are top and bottom perspective views of the elastomeric member that may be used in the bounce back element.

### DETAILED DESCRIPTION OF THE INVENTION

The invention has numerous advantages over prior practices in the art. The invention removes the chisel from the concrete without requiring additional energy to be expended by the operator of the percussion demolition device. Further, as the invention extracts the chisel a larger hole is created which aids in further demolition. The invention device, while creating the advantages as set forth above, does not require extra physical effort by the operator in operating the air hammer. In fact, the effort required is less as the operator does not need to wrestle with the percussion hammer to remove the chisel from holes. The invention also extends the life of the hammer bits as they are not abused during extraction from the concrete. These and other advantages will be apparent from the detailed description below.

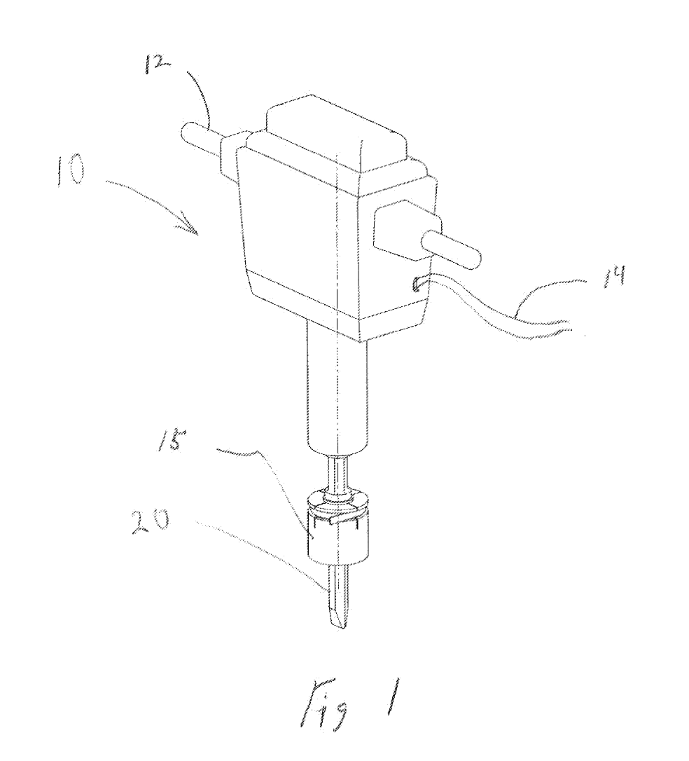

In FIG. 1, a percussion air hammer 10 is illustrated. The air hammer 10 is provided with grips 12 and air hose 14. The air hose 14 is connected to an air compressor, not shown, to supply high-pressure air to the hammer 10. The air hammer 10 drives a bit or chisel 20 that is provided with the resilient bounce back bit extractor element 15 of the invention.

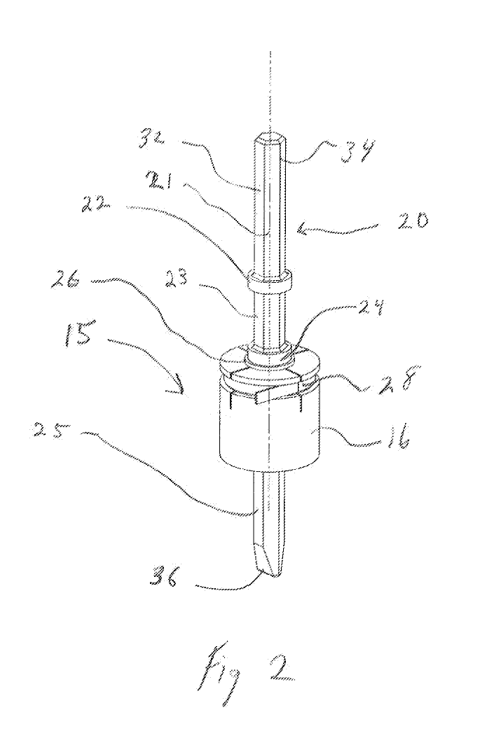

FIG. 2 is a perspective view of a chisel 20 with the resilient extractor element 15 mounted on the chisel 20. The chisel 20 is provided with two protuberances 22 and 24 separated by area 23. Protuberance 22 is provided for engaging the chisel shaft with the air hammer in the conventional way. Protuberance 24 is shown as a retainer collar that serves as a stop for the bounce back element 16. Washer 26 is provided between retainer collar protuberance 24 and resilient member 16. The bounce back element 15 is held to the chisel by strap 28. It is noted that the chisel 20 is not round in the cross-section but it is provided with a series of lands 32 and ridges 34 leading to the chisel point 36. Chisel portion 21 extends into the hammer and the working chisel portion 25 is below the retainer collar 24.

FIG. 3 is a perspective view of the chisel and resilient bounce back element 15 prior to assembly. In assembling the invention, the washer 26 is placed on the chisel 20 and moved up against the retainer collar protuberance 24. The elastomeric member 16 is moved up against the washer 26. The elastomeric member is then fastened to the chisel 23 by tightening the strap 28 in the groove 36.

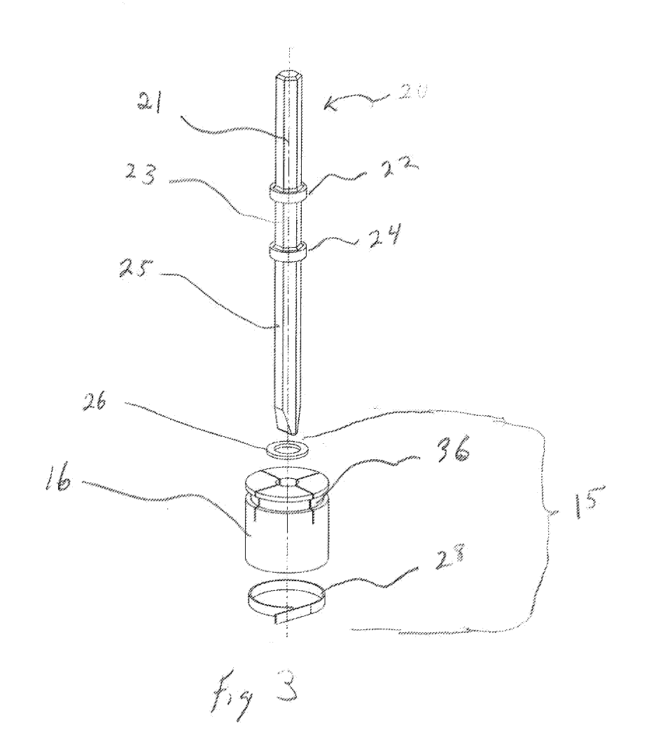

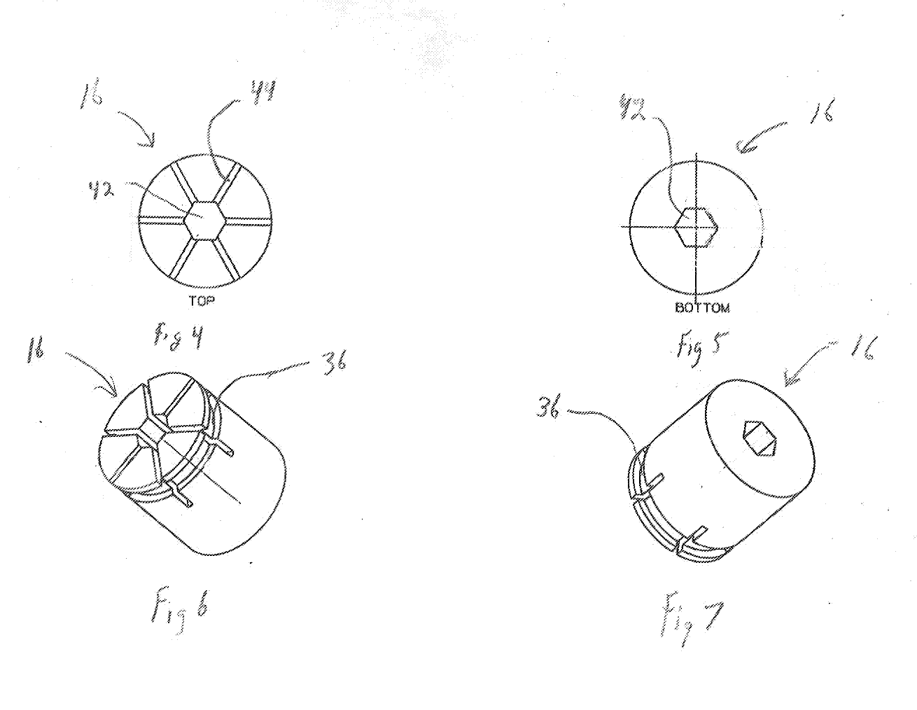

FIGS. 4 and 5 are top and bottom views, respectively, of the elastomeric member 16 utilized in the invention. FIGS. 6 and 7 provide perspective top and bottom views of the elastomeric member 16 utilized in the invention. The elastomeric member 16 is provided with a channel 42 where the chisel will pass through the elastomeric member. The elastomeric member further is provided with cutouts 44 that extend to below the groove 36 where the fastening strap 28 will be located. By providing these grooves 44, the top of the elastomeric member 16 will collapse and deform when the fastening band 36 is tightened causing the elastomeric member 16 to be tightly held to the chisel.

The protuberances 22 and retainer collar 24 on the chisel are each shown as a continuous annular addition to the chisel. The protuberances would not need to be continuous around the chisel shaft and could be formed in separated portions. It is preferred that the protuberances be formed by forging the chisel with the protuberances integral with the rest of the chisel. The protuberances may be welded to the chisel but are more likely to break both at the protuberance holding the elastomeric member and at the protuberance that fastens the chisel to the percussion hammer. The protuberance 22 for fastening to the percussion hammer may be any design to fit the particular percussion hammer being utilized. The protuberance 24 may be any shape that will stop washer 26 and not break during usage. A retainer collar is, as illustrated, preferred as it is less likely to break than other shapes of protuberances. A chisel with an integral forged protuberance is much more reliable than a welded protuberance, which is more subject to breakage during use.

The chisel generally is about 19″ long. Typically, about 6″ of the chisel will extend above the protuberance 22 for placement into the hammer. The lower collar 24 is generally between 2.5″ and 3.5″ below the protuberance 22. The chisel bit then extends about 9″ below the retainer collar protuberance 24. In one preferred embodiment, the chisel 20 has an overall length of 19″. The hammer portion 21 is 6″ long; the work bit portion 25 is 9⅛″ long; and the portion 23 between the protuberances 22 and 25 is 2⅜″ long. The protuberances are each ½″ on the shaft, which is 1⅛″ in diameter.

While the bit or chisel illustrated herein has a hexagonal cross-section, it is possible to use chisels of other cross-section such as round. It is also possible that the bit or chisel could have a star shape or point rather than the chisel end illustrated. The term chisel as used herein is intended to include bits provided with other than chisel points unless specifically indicated.

The strap 28 holding the elastomeric member 16 in place may be any strap convenient to use. The strap needs to be able to be tightened quickly and not loosen during use. Typical of such straps are hose clamps, plastic clamps such as for electrical ties, and metal clamps, which are semicircular with two of the clamps bolted to each other to compress the elastomeric member 16. The washer 26 generally would be formed of steel and of diameter sufficient to spread the compression load on the elastomeric member 16 so it is less likely to crack or deform at the upper side.

The size of the elastomeric member 16 may be any effective length and width that does not interfere with the operation of the chisel. The size will vary depending on the properties of the elastomeric member and the size of the jack hammer. The elastomeric member generally is of such size as to not need to greatly deform to provide the rebound or bounce back required to remove a chisel from a hole. Not having excessive deformation will prolong the elastomer's life. It is generally desirable that compression of the elastomeric member be less than 50% to cause rebound of the chisel and have long life of the elastomer. Any suitable width and length of elastomeric member may be utilized that is effective. Generally, the width would be between about 3″ and 4″ and the length (along the central hole) between about 3″ and 5″. A length of about 4″ is preferred for good rebound without interfering with the working depth of the chisel. The washer would have a diameter of about an inch and a half. A chisel is typically about 1.1″ in diameter.

The elastomeric member 16 should be abrasion resistant, particularly at the end that contacts the concrete, blacktop, or other hard surface. It is known to increase abrasion resistance of elastomers by embedding fiberglass, fiberglass cloth, metal wire, metal particles, or ceramic particles in the elastomeric member 16. The durometer should be such that the elastomeric member 16 has properties that will allow good bounce back when the chisel contacts the concrete. Generally, the durometer would be between about 40 and 80. A preferred durometer property would be between 55 and 65 to provide a good bounce back element and sufficient toughness to survive the use with the chisel of the percussion hammer. The tensile strength of the elastomeric member 16 should be sufficient to provide long life to the elastomeric member that provides the bounce back element for the chisel. A tensile strength of between 800 and 1500 pounds per square inch (psi) has been found to be suitable. A preferred tensile strength is about 1000 psi for good bounce back and long life. The elongation of the elastomeric member may be any suitable amount that results in an elastomer with good bounce back or rebound elements. An elastomeric member with an elongation to breaking of between 250% and 350% has been found to be preferred for long life and good bounce back. The elastomeric member also should maintain bounce back properties over the temperature range where the percussion hammer may be used. This typically would be between −25° F. and 175° F.

The elastomeric member 16 may be formed of any suitable polymer composition that results in suitable properties for the bounce back feature and long life. Suitable compositions are elastomeric polymers and blends of synthetic and natural elastomers. A preferred elastomeric composition has been found to be a styrene butadiene rubber for long life and desirable bounce back properties. The resin is preferably reinforced with material such as fiberglass cloth to aid in preventing wear where it contacts the concrete. Other reinforcement materials for elastomerics are steel wires and ceramic particles that may be used in the invention.

The cutouts 44 in the top of the elastomeric member may be any size that provides for achieving a good grip on the chisel when the strap is tightened, but does not weaken the elastomer such that it will deteriorate in that area. Typically, the cutouts would be between ⅛″ and ⅜″ wide and extend down about an inch from the top of the elastomeric member.

While described as the elastomeric member, it is also possible that other materials could be used to create the bounce back feature for a percussion chisel. For instance, springs could be utilized instead of the elastomer. The springs would be mounted on the chisel such as they are mounted around a central Pogo stick shaft such that when the chisel enters into a certain depth of the concrete it would compress the spring on the shaft of the chisel and cause rebound.

While discussed with use of a pneumatic percussion hammer, it is also possible that the invention can be used with other types of percussion hammers powered by electricity or hydraulics.

1. A demolition tool comprising a chisel and a bounce back element.

2. The demolition tool of claim 1, wherein the chisel shaft is provided with a protuberance integral with the chisel shaft that locates the bounce back element on the shaft of the chisel.

3. The demolition tool of claim 2, wherein the protuberance that locates the bounce back feature is a retainer collar.

4. The demolition tool of claim 1, wherein the bounce back element comprises an elastomeric member surrounding the chisel shaft.

5. The demolition tool of claim 4, wherein the elastomeric member is held to the chisel by an annular clamp.

6. The demolition tool of claim 4, wherein the elastomeric member has an annular groove where the clamp is located.

7. The demolition tool of claim 2, wherein the chisel further contains a protuberance to locate the chisel in the demolition tool.

8. The demolition tool of claim 1, further comprising an air hammer.

9. The demolition tool of claim 4, wherein the elastomeric member has a durometer of between 55 and 65.

10. A bounce back chisel for a demolition tool comprising a chisel and a bounce back element.

11. The chisel of claim 10, wherein the chisel has multiple planar sides meeting at ridges along the chisel shaft.

12. The chisel of claim 10, wherein the bounce back element comprises an elastomeric member surrounding the chisel shaft.

13. The demolition tool of claim 12, wherein the chisel shaft is provided with a retainer collar integral with the chisel that locates the bounce back element on the shaft of the chisel.

14. The demolition tool of claim 12, where the elastomeric member is held to the chisel shaft by an annular clamp.

15. The demolition tool of claim 12, wherein the elastomeric member has an annular groove where a clamp is located.

16. The demolition tool of claim 12, wherein the elastomeric member has a durometer of between 55 and 65.

17. A method of breaking up concrete comprising bringing a percussion demolition tool comprising a chisel and a bounce back element into contact with the concrete.

18. The method of claim 17 wherein the bounce back element comprises an elastomeric member surrounding the chisel shaft.

19. The method of claim 17, wherein the chisel is provided with a protuberance integral with the chisel that locates the bounce back element on the shaft of the chisel and wherein the chisel further contains a protuberance to locate the chisel in the demolition tool.

20. The method of claim 18, wherein the elastomeric member is held to the chisel by an annular clamp.

21. A demolition chisel comprising a chisel shaft having two spaced apart, integrally forged protuberances along the shaft of the chisel.

22. The demolition chisel of claim 21, wherein one protuberance is adapted to locate the chisel in a percussion tool and the other protuberance is adapted to locate a bounce back element.

23. The demolition chisel of claim 22, wherein the protuberance adapted to locate a bounce back element comprises a retainer collar.
